(19) United States
(12) Patent Application Publication
(10) Pub. No.: US 2024/0037319 A1
(43) Pub. Date: Feb. 1, 2024

(54) Referencing a User in Chat to Provide Easy Connections

(71) Applicant: Zoom Video Communications, Inc., San Jose, CA (US)

(72) Inventor: Randy Oh, Dublin, CA (US)

(21) Appl. No.: 17/877,340

(22) Filed: Jul. 29, 2022

(51) Int. Cl. G06F 40/134; H04L 51/04; G06F 3/0482; G06F 40/274

(52) U.S. Cl. CPC G06F 40/134; H04L 51/04; G06F 3/0482; G06F 40/274

(57) ABSTRACT

An example embodiment of the present disclosure includes a method for referencing a user in chat. The method includes joining a chat session having a chat window for displaying text messages shared between at least a first user and a second user, providing a text entry area to receive text messages from the first user, and receiving a reference special character and a character or character string corresponding to one or more names for at least one third user within the text entry area. The method also includes generating an interactive link to one of one or more names based on the reference special character and the character or character string associated with the reference special character and displaying the interactive link in the chat window, the interactive link providing access to user information associated with the at least one third user without notifying the at least one third user.

### FIELD

The present disclosure relates generally to referencing a user in an online chat program, and more particularly, to providing additional information about one or more referenced users outside the current chat window.

### BRIEF DESCRIPTION OF THE DRAWINGS

FIG. 1 is an illustration depicting an example video conferencing system in accordance with various embodiments.

FIG. 2 is an illustration depicting an example video conferencing system in accordance with various embodiments.

FIG. 3 is an illustration of an example graphical user interface (“GUI”) in accordance with various embodiments.

FIG. 4 is a flow chart depicting a process for using a reference in accordance with various embodiments.

FIGS. 5A, 5B, 5C, 5D, 5E, 5F, 5G, and 5H are illustrations of an example graphical user interface (“GUI”) in accordance with various embodiments.

FIG. 6 shows an example computing device suitable for use with systems and methods in accordance with various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Chat features are commonly implemented in video-conferencing tools, among others. Including a chat feature in a video-conferencing tool provides the ability for users to communicate without interrupting the main audio/video conversation occurring simultaneously. The chat in the video-conferencing tool can also be used to record action items, plan action around common resources, and include additional information.

The present disclosure relates to systems and methods that provide a mechanism to find and reference another user quickly in chat to allow for quick lookup of the user to foster fluid introductions and connections.

There are oftentimes cases where users are in a chat session and one of the users wants to reference another person, without notifying that person. One of the benefits of referencing another person can include allowing for easy auto completion of the name for the user typing, to assist in accurately spellings long or hard to remember names. Traditionally, users have to manually type in the whole name of a person being referenced from memory, which leaves it open for misspellings, incorrect person being referenced, etc., especially with more difficult, longer names.

The reference can also create a link to a user profile card that allows users in chat to hover over the name being references to see the user profile card. This would allow the viewer to quickly find out key things about the referenced person such as their job title, picture, department, etc. For the other user(s) participating in the chat, trying to look up the person being referenced can also require additional steps. For example, the user(s) may need to copy and paste the referenced name from chat into another program or directory to lookup information about the referenced user. However, this can be a labor-intensive process that is susceptible to errors, for example, if there was a misspelling of the name being copied and pasted.

In operation, a user can reference another user using a special character (e.g., ‘?’) before, and start typing the target user's name. Typing the special character can cause a search to pop up with a list to allow easy auto completion of the name of the other user for the typer. When the chat message is posted, the message will include all the text typed with the string included with the special char being associated with a hyperlink. The posted string with the reference character also enables viewers to be able to hover over the name to show the user profile card. If user clicks on the string with the reference character, the user shall be redirected by the hyperlink to the contact page for that user. This allows for a user to easily reference the right person to introduce them to someone else and allows the person receiving the chat to quickly learn about this person and reach out. Additionally, the referenced user will not be informed/notified.

Regardless of the type of chat program can being used to discuss and reference other users, the present disclosure provides methods and systems for referencing another user in an efficient manner, in which additional information can be provided about the user, while not notifying the user being referenced. Any user can be referenced, even if they are not subscribed to a particular chat session, channel, application, etc. and will be referenced without the user having any knowledge of the reference.

System Overview

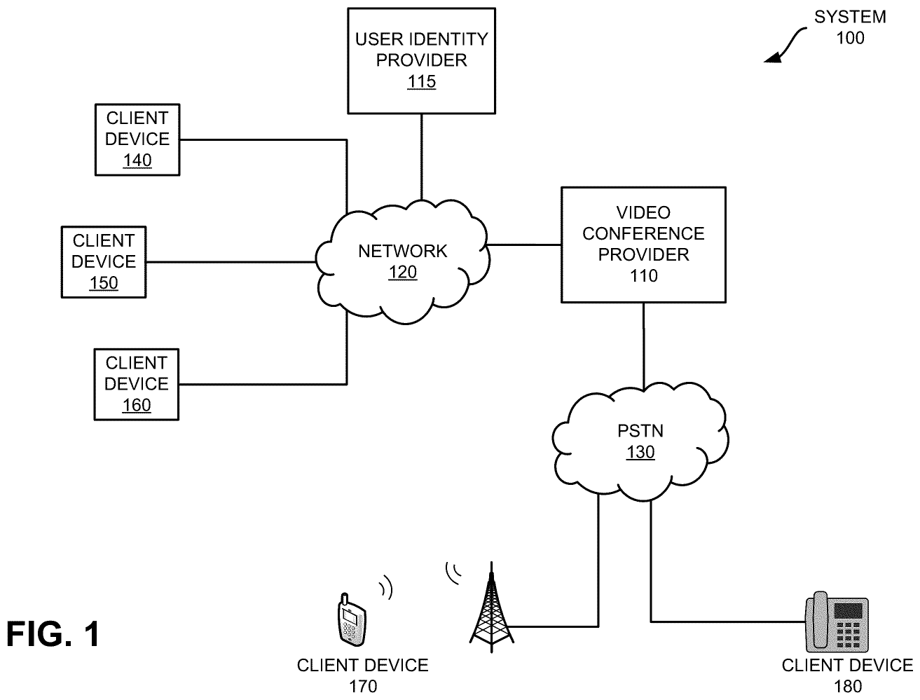

Referring now to FIG. 1, an example system 100 that provides videoconferencing functionality to various client devices is depicted. The system 100 includes a video conference provider 110 that is connected to multiple communication networks 120, 130, through which various client devices 140, 150, 160, 170, 180 can participate in video conferences hosted by the video conference provider 110. For example, the video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the video conference provider 110 over a public network.

The system 100 optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

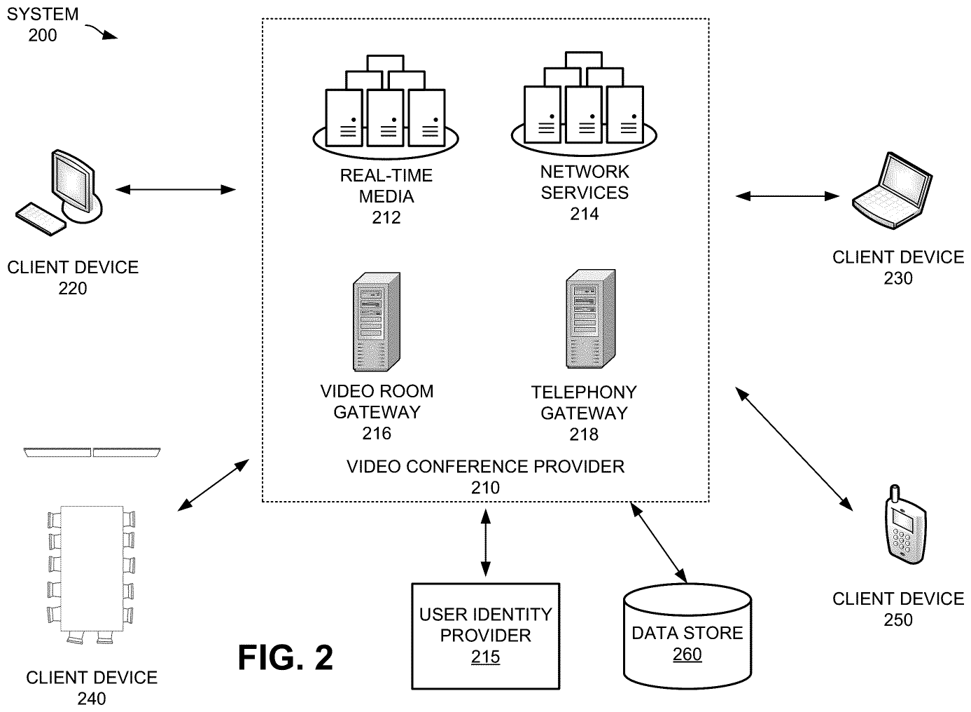

Video conference provider 110 allows clients 140-160 to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms or other “chat” rooms. Such breakout rooms or “chat” rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices (i.e., client devices 170, 180), the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider 110 may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 110, which is displayed by the respective client device 140 to enable the various users to participate in the meeting. The participants may also employ their client devices 140-180 to capture text information to the video conference provider 110. Similarly, the participants may also receive text information from the video conference provider 110, which is displayed by the respective client device 140 to enable the various users to participate in the meeting through text messages (or chat messages).

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device 170-180, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, an example system 200 in which a video conference provider 210 provides videoconferencing functionality to various client devices 220, 230, 240, 250 is depicted. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different aspects of video conference functionality, thereby enabling the various client devices 220-250 to create and participate in video conference meetings. The video conference provider 210 uses one or more real-time media servers 212, one or more network services servers 214, one or more video room gateway servers 216, and one or more telephony gateway servers 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams and text messages typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams (and text messages) based on the target client device and communicate multiplexed streams to each client device. For example, the real-time media servers 212 receive audio and video streams and text messages from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers 214 may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider 210, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider 210 to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

Continuing with FIG. 2, the system 200 may include one or more data stores 260 for managing various collections of data, databases, algorithms, etc. For example, the one or more data stores 260 can store data for managing the video conferencing software, data related to a user and/or an organization using the video conferencing software, data related to data (e.g., audio, video, text, etc.) shared during a video conference, etc. The one or more data stores 260 can include any combination of computing devices configured to store and organize a collection of data. For example, one or more data stores 260 can be a local storage device on one or more of the client devices 220-250 or on or more of the servers 212-218, a remote database facility, or a cloud computing storage environment. The different components of the system 200 can communicate and otherwise share data with the one or more data stores 260 over any combination of local buses, the network 120 and the PSTN 130. The one or more data stores 260 can also include a database management system utilizing a given database model configured to interact with a user for analyzing the database data.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

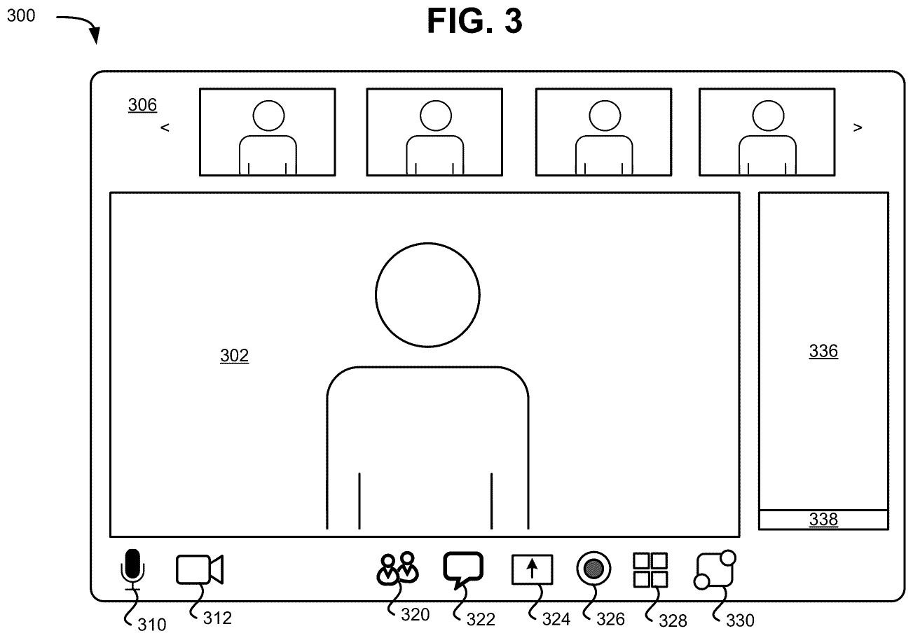

Referring now to FIG. 3, FIG. 3 shows an example graphical user interface (GUI) 300 that a participant's client device may display while interacting with another participant during a virtual expo in a conversation. A client device, e.g., client devices 220-250, executes video conferencing software, which in turn displays the GUI 300 on the client device's display. In this example, main viewing area 302 may display various images, depending on the configuration of the GUI 300 chosen by the videoconference participant. In this example, main viewing area 502 is displaying an image of the current or active speaker in a videoconference. The GUI 300 also includes a gallery strip 306. Gallery strip 306 displays thumbnail images of the most recent speakers in the videoconference. The GUI 300 also includes a toolbar that includes various user controls, as examples, controls for video devices, microphones, chat functions, gesture functions, and recording functions. Controls 310-312 may allow the participant to toggle on or off audio or video streams captured by a microphone or camera connected to the client device. Control 320 allows the participant to view any other participants in the video conference with the participant, while control 322 allows the participant to send text messages to the other participants. Control 324 allows the participant to share content from their client device. Control 326 allows the participant to toggle recording of the meeting, and control 328 allows the user to select an option to join a breakout room, though in this example, with only two participants, breakout room functionality may be disabled. Control 326 allows the participant to toggle various applications that may be integrated with the video conferencing software. The GUI 300 also includes a chat window 336 and chat text entry area 338, which may be toggled by control 322, to allow the participants to exchange text messages.

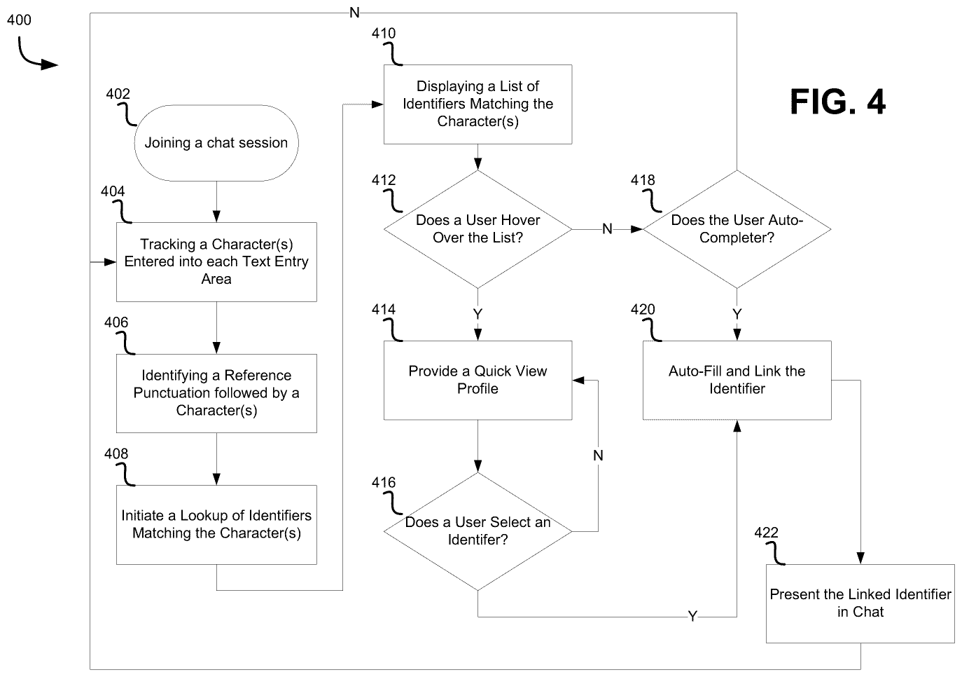

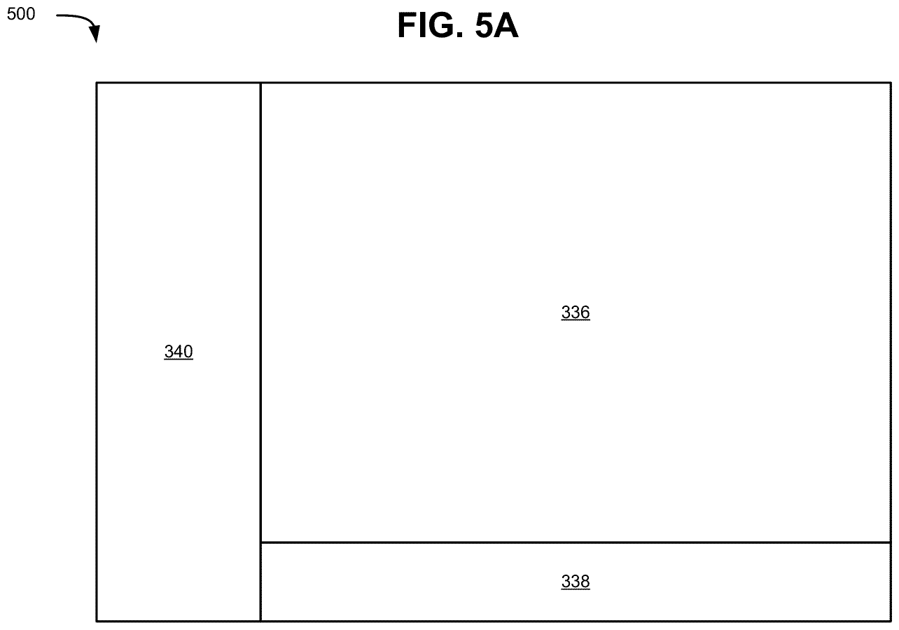

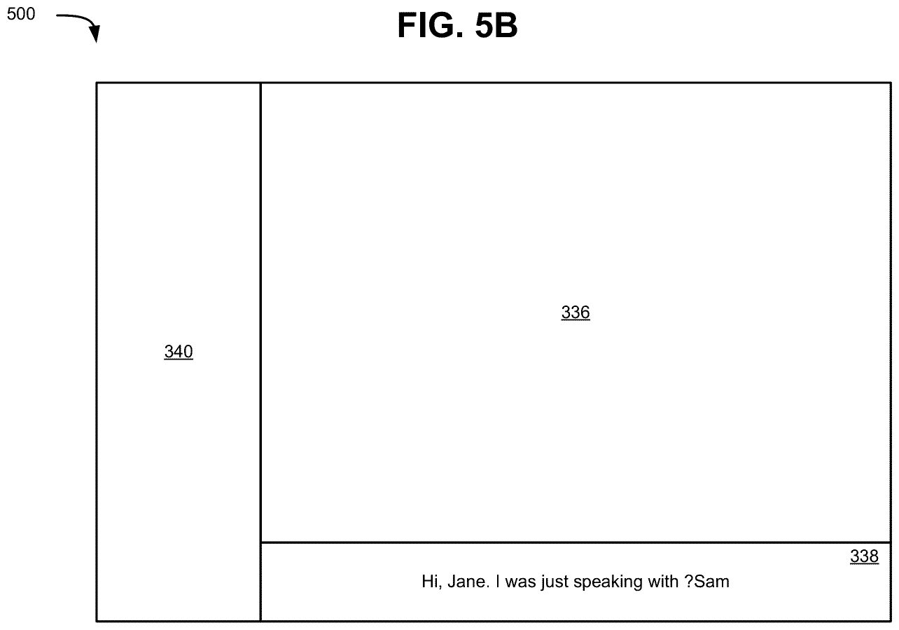

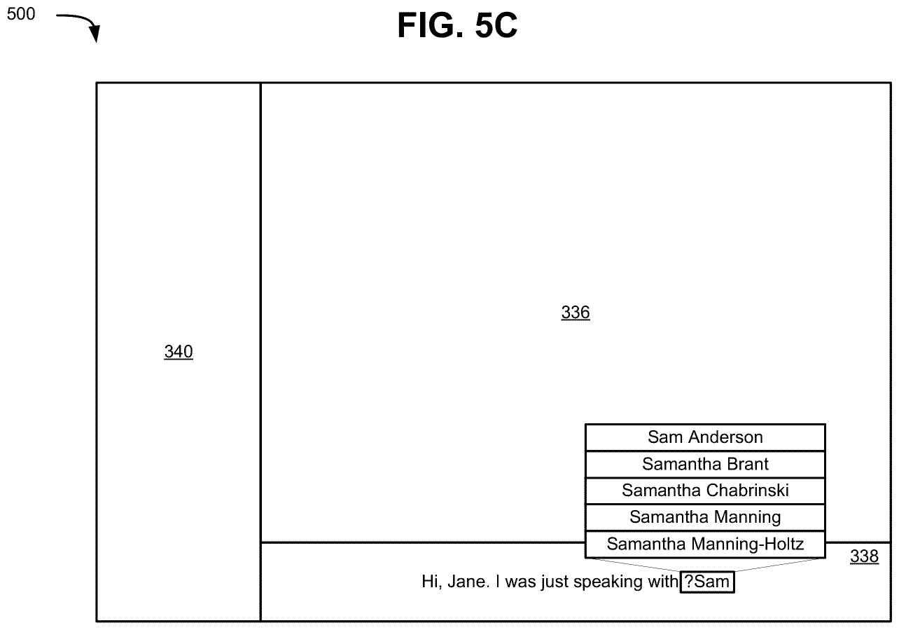

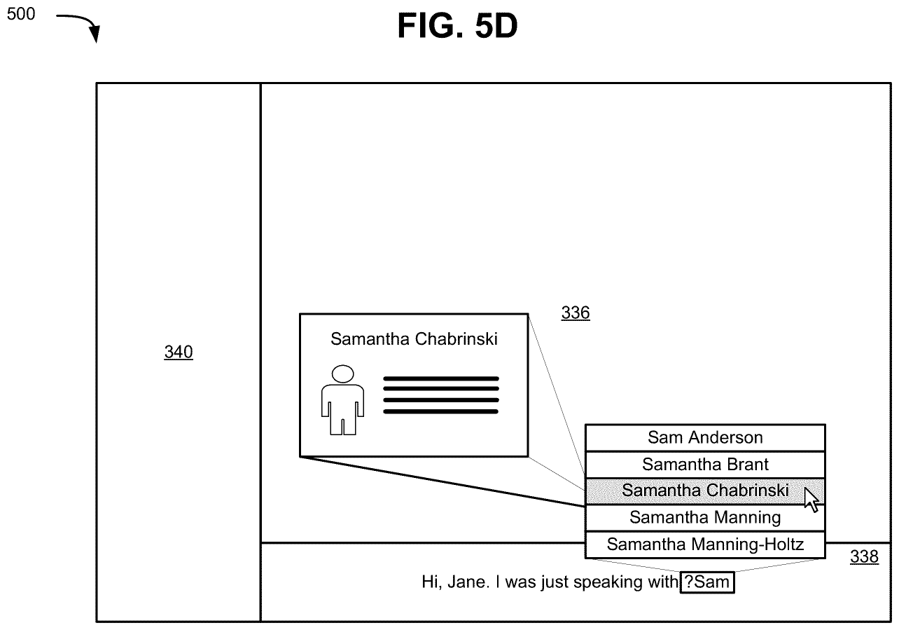

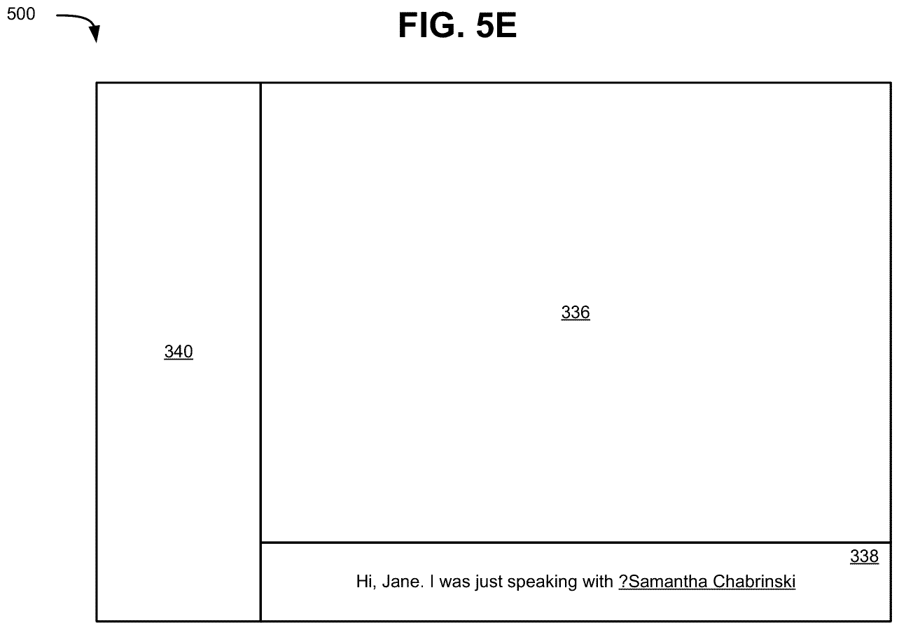

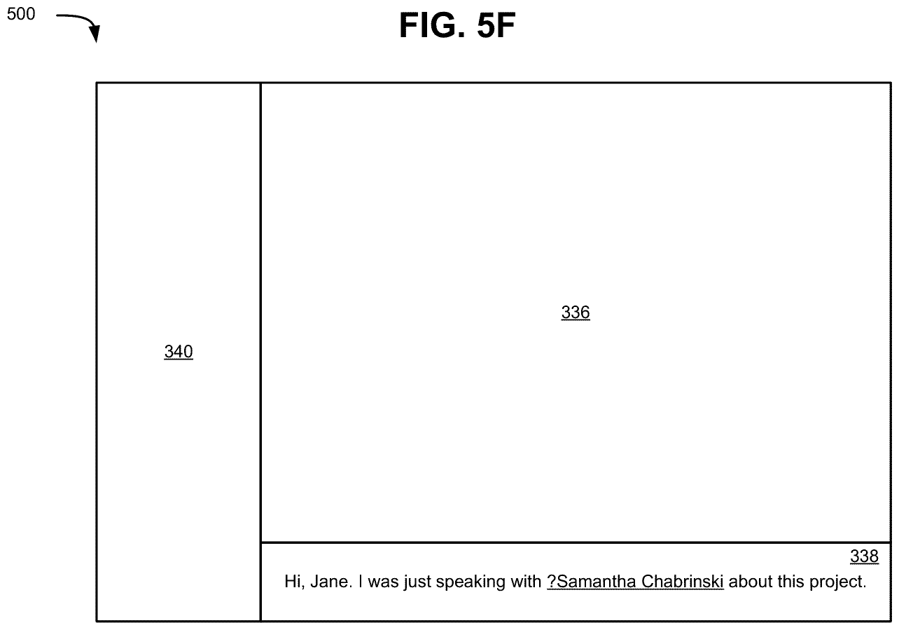

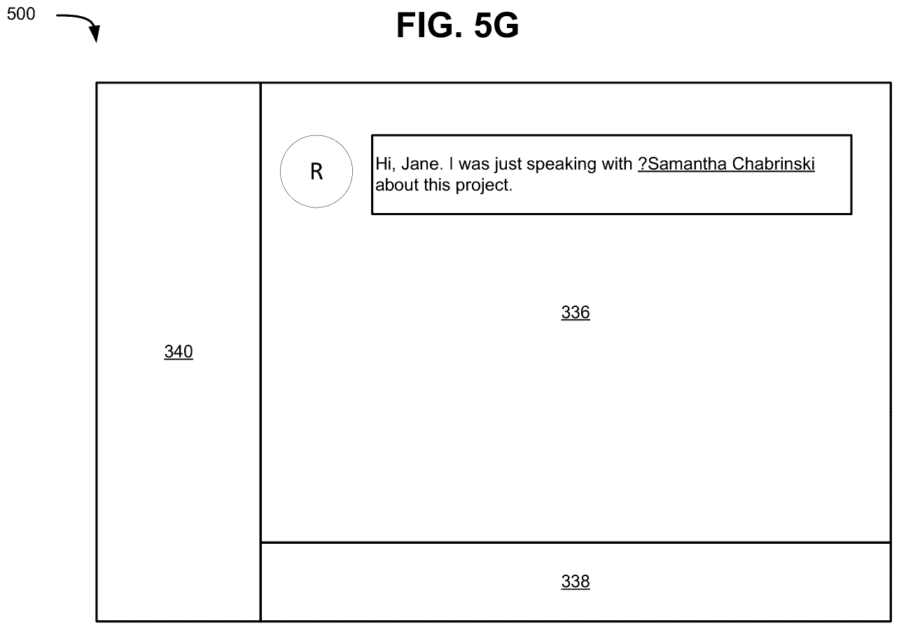

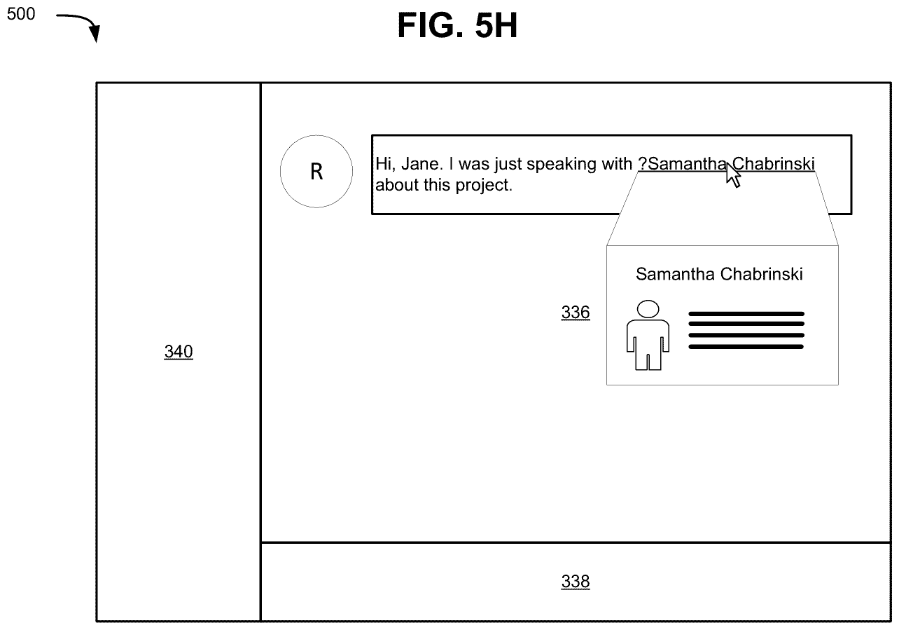

Referring now to FIG. 4, FIG. 4 shows an example method 400 for referencing a user in a chat window. Referencing a user can entail using a special character followed by an identifier (e.g., a name of a person) to create an in-chat link to a user profile for the referenced identifier. The method 400 of FIG. 4 will be described with respect to the system 200 shown in FIG. 4 while referencing the GUIs in FIGS. 5A-5H; however, any suitable systems and GUIs according to this disclosure may be employed. In one example, the blocks provided in process 400 can be performed by any combination of the servers 212-218 and clients 220-250.

At block 402, a chat session is initialized. The chat session can be initialized in any combination of programs using any combination of execution steps. For example, the chat session can be automatically initialized as part of a video conference initialization, for example, as shown in FIG. 3. In another example, initializing a chat session can include opening another chat application, either by selecting control 326 in the video conference GUI 300 or opening a separate dedicated chat program. The chat application can load a GUI having a chat window 336 with the chat text entry area 338, among other features. For example, as depicted in FIGS. 5A-5H, the chat application can include a GUI 500 having a chat window 336, a chat text entry area 338, a side panel 340. The chat window 336 and the chat text entry area 338, in FIGS. 5A-5H, can include the same functionality as the same parts discussed with respect to FIG. 3.

In some embodiments, one or more of the servers 212-218 (or other server(s)) can establish a chat session between two or more users in response to receiving one or more requests to initiate a chat between the two or more users. The connection can be established using any combination of techniques, for example, peer-to-peer, client-server, etc. For example, to join or access the chat session in a video conference GUI 300, a participating user can select the control 322 to open the chat window 336 with the chat text entry area 338. The participating users in the chat session can include any users invited to a meeting or video conference and has joined to meeting or video conference.

The chat program can be part of the video conferencing program, as depicted in FIG. 3, or a standalone chat program. FIG. 5A depicts an example chat session GUI 500 having the chat window 336, the chat text entry area 338, the side panel 340. This can be part of the GUI 300 in FIG. 3 or a separate chat session window, breakout room, etc. Regardless, the chat window 336 and the chat text entry area 338 can operate as discussed with respect to FIG. 3. The side panel 340 can include any combination of chat tools, organization, recording that may be useful to a user. For example, the side panel 340 can include mentions, missed messages/calls, chat requests, add requests (e.g., friends, coworkers, etc.), as well as channels for different chat sessions or chat groups.

Once a chat session is initialized, a user can view text messages submitted by other users in the chat window 336 and can enter their own text messages using their chat text entry area 338. In some instances, access to the chat window 336 and/or the chat text entry area 338 can be limited to certain users. For example, an anonymous participant in a video conference may not be able to access the chat session or aspects of the chat session. The steps in process 400 can be used interchangeably regardless of what type of program has created the chat session. Initially, the chat window 336 and the chat text entry area 338 being empty, for example, as depicted in FIG. 5A. Thereafter, the participating users can share text messages by entering text into the chat text entry area 338 and submitting the text into the chat window 336.

There are oftentimes cases where users are participating in one to one or group chat, and a user want to reference another person, without notifying that person. For example, the person being referenced may not be one of the participants within the chat session or the particular comment isn't relevant to the person or doesn't require their attention; however, providing identifying information about the person to others in the chat may be desirable. For the user typing, it would be preferable to enable auto completion of the name of the person being referenced, especially for longer harder to spell names.

At block 404, the process 400 tracks each character entered into each chat text entry area 338, at each user client. The character entry can be tracked using any combination of methods. The tracked characters can be compared against predetermined patterns to determine whether a particular sequence of characters has been entered by the user to trigger a particular functionality. Examples of functionalities include references, mentions, etc. Tracking the characters can include tracking each character as they are entered along with a predetermined string length of adjacent characters. The functionalities can be tracked and stored as part of the design of the video conferencing software or chat program. The tracking and comparing can be performed by any combination of a client or server devices. For example, the client GUI can receive the text and deliver the text to a server device for processing (e.g., comparison). Alternatively, the tracking and comparing can be performed entirely by the client device.

Referring to FIG. 5B, the GUI 500 shows the text being entered within the chat text area 338 as a user begins to enter text into the chat text entry area 338. For example, in FIG. 5B, the user types “Hi, Jane. I was just speaking with ?Sam”. As the text is entered within the chat text entry area 338, the characters are monitored for the special character. For example, the special character trigger can include a space, adjacent to the question mark (e.g., special character), adjacent to one or more characters. In other words, the special character (i.e., the question mark) will only trigger when a new string is started with the question mark.

At block 406, the process 400 identifies a pattern, entered into the text entry area 338, having a predetermined number of adjacent characters matching a Reference functionality. The Reference functionality is triggered when a new word is started with a special character (or punctuation), for example, a question mark ‘?’. Usage of the special character in a particular order will trigger the Reference functionality, for example, when a space is followed by a special character (chosen by the developer) adjacent to a character following the question mark. For example, the process 400 identifies a space followed by a ‘?’ followed by a character or string of characters (i.e., “?S”). This pattern can be identified as an acceptable pattern for triggering the Reference functionality.

The special character and Reference pattern can include any combination of patterns, punctuation, etc. based on user preference, and is not limited to the use of a space followed by a question mark followed by one or more characters. Although process 400 is specific to the Reference function, depending on the one or more functionalities associated with different patterns having different criteria with different special character(s), a different functionality can be triggered and launched by the program running the chat session. The pattern identification can be performed by any combination of a client or server devices. For example, the client GUI can receive the text and deliver the text to a server device for processing (e.g., pattern identification). Alternatively, the pattern identification can be performed entirely by the client device.

At block 408, in response to triggering the Reference functionality, the process 400 initiates a lookup of identifiers matching the character(s) matching the string that triggered the Reference functionality. The matching identifiers can be accessed using any combination of methods from any combination of data sets. For example, the string following the special character provided within the text entry area 338 can be compared against all of the identifiers (e.g., names) within a business or organization directory (e.g., within data store 260) linked with the video conferencing or chat application(s). This process can entail a directory lookup by accessing a database or directory outside of the local users in the chat channel, chat session, etc. The database can include multiple organizational accounts that are independently controlled or linked. For example, the video conferencing software can access a directory of names within an Outlook® directory database to compare against names throughout an organization, regardless of whether they have the chat program or use the chat program at that current point in time. In another example, the video conferencing program or chat program can aggregate a list of identifiers or people to create a global directory. Thus, the directory including the names or identifiers can include any lists of entities stored within a combination of local and remote storage. The identifier lookup can be performed by any combination of a client or server devices. For example, the server device can perform identifier lookup/comparison on the text received from the client GUI. Alternatively, the identifier lookup can be performed entirely by the client device.

The identifiers can include any combination of names or other identifying strings that match the character(s) within the triggering string. For example, the identifier can be a first name, last name, username, etc. Continuing the example from block 406, the list would include any identifiers that started with the character ‘S’, with the ‘ ?’ portion of the string “?S” being part of the Reference trigger with the remaining character(s) being the target identifier. This sequence can trigger generation of a list including a prediction of one or more names that the user intends to reference prior to the user finishing entering the whole name of the referenced person. The matching can be provided on the fly as the user is entering text into the text entry area 338. Similarly, the matching will be updated based on additional characters being added to the text within the text entry area 338. For example, if the next character entered is ‘a’ (i.e., “?Sa”), then the list would be updated to include all identifiers starting with ‘Sa’. Therefore, any additional characters added over time would cause the list to be updated and may shorten the list.

At block 410, a list of identifiers (e.g., names) matching the character(s) within the triggering string are organized and displayed within a list. The list can be generated from the matching identifiers provided in block 408 using any combination of ordering criteria. For example, the identifiers within the list can be ordered based on alphabetical order, hierarchical order, frequently used order, proximity order, etc. The list of identifiers can be organized using any combination of methodologies. For example, the list can be generated using a multiple sorting algorithm to order the recommendations based on a prediction of who the algorithm believes the user is intending to reference. The algorithm can take into account any combination of interactions (e.g., meetings, chat, email, etc.), relationships (e.g., team members, shared departments, shared projects, etc.), historical data, user preference, etc. when forming a prediction and organization of the list. In some instances, the list can be a hybrid order with the top suggestion(s) being based on a predictive algorithm with the remaining suggestions being provided in alphabetical order. The list generation can be performed by any combination of a client or server devices. For example, the server device can generate the list and provide the list back to the client device for display. Alternatively, the list generation can be performed entirely by the client device.

The identifiers in the list can be provided to the client device for auto completion of the intended identifier. FIG. 5C depicts the GUI 500 rendering an example list of names being displayed from the “?Sam” reference trigger. For example, the list includes the names of Sam Anderson, Samantha Brant, Samantha Chabrinski, Samantha Manning, and Samantha Manning-Holtz. The list is provided such that a user can quickly select the intended name for autocompletion while avoiding having to spell out the entire name themselves, thus, avoiding potential typos, misspellings, etc. When providing predictive auto fill of an identifier (e.g., a person's name), it would be helpful to first confirm that the auto fill is for the intended identifier. To provide visual confirmation, the GUI can allow the user to hover over one or more suggested/predicted names to quickly view a user profile card associated with those names. This preview enables a user to find out key things about the referenced person, such as their job title and department. If the user typing does not want the predictive list or auto fill, the user can cancel the reference function, for example, by hitting the esc key. If a triggered reference function is not canceled, the list may continue to be updated and provided to a user until a selection (or cancelation) is made.

The example list in FIG. 5C is provided in alphabetical order for all people with first names beginning with Sam, however, the list can be organized in any combination of orders. Instead of being organized alphabetically, the list can provide top choices that are predictive of what the system believes the user would be typing based on any combination of data. For example, Samantha Chabrinski could be provided at the top of the list because the user typing frequently interacts with Samantha Chabrinski. The list can also be generated based on any combination of identifiers, such as for example, first names, last names, usernames, etc.

Continuing with block 410, each of the identifiers included within the list can be associated with a profile card. For example, the list can be a list of names, each associated with a user profile card. The list can be deployed within and/or extending from the string within the text entry area 338 and can be selectable and scrollable. The list can include any number of results, for example, the top five results in a short list or a long exhaustive list including all possible matched. Continuing the example from block 408, the list would include any identifiers that started with the character ‘5’. As noted above, any additional characters entered thereafter would shorten the list. For example, if the next character entered is ‘a’ (i.e., “?Sa”) then the list would include all identifiers starting with ‘Sa’.

At block 412, the process 400 tracks movement of a mouse curser of the user while text is being entered into the text entry area 338. Once the list from block 410 is generated and displayed, the mouse curser can be tracked to determine whether the mouse curser is positioned over one of the identifiers within the list. The mouse curser tracker can be performed using any combination of methods. For example, process 400 receives cursor coordinates and determines when it is located over one of the identifiers using a conventional windowing/event functionality. If the mouse curser is positioned (i.e., hovering) over an identifier within the list, then the process 400 will advance to block 414, otherwise the process 400 will advance to block 418. The same determination can be provided detecting a different combination of actions from the user. For example, detection that the user mouse clicks on an identifier in the list, detection that the user uses the mouse wheel to scroll through the list, detection that the user uses the arrow keys to scroll through the list, etc. can be included within the detection steps in block 412.

At block 414, in response to an event detection associated with one of the identifiers in the list, a quick view profile is provided. For example, when the process 400 detects that a curser is hovered over one of the identifiers within the provided list, then a quick view profile associated with that identifier is provided. The quick view profile can be associated with the identifier in any combination of methods. For example, the quick view profile can be associated with the identifier within a database or table (e.g., within data store 260).

FIG. 5D depicts the GUI 500 rendering a quick view profile rendered when a name is hovered over by the curser. In FIG. 5D, the curse hovers over Samantha Chabrinski within the list and the quick profile for the person named Samantha Chabrinski is rendered. The user can use the quick view profile to confirm they are selecting the right person for the auto fill. This functionality can help to avoid any potential confusion with closely related names (e.g., Samantha Manning vs Samantha Manning-Holtz). The quick view profile can include any combination of information that may assist a user in confirming the proper identification of the identifier highlighted within the list. For example, the quick view profile can include a name, title, location, biographical data, photograph, etc. for a user associated with the named identifier being hovered over. The quick view profile can also include buttons for additional actions. For example, the quick view profile can include a favorite button, an add friend button, an initiate chat button, a block button, etc.

By providing the quick profile views just by hovering the cursor over the list, a user can quickly preview each of the names without having to click to select, then close the window after reviewing, and clicking again, etc. The quick profile can include any combination of information about a person. The quick view profile in FIG. 5D, for example, includes a full name, a profile picture, and a short biography. The quick profile can also include additional functionality, such as favorite button, chat button, add contact button, etc.

At block 416, the process 400 monitors to determine whether the user selects one of the identifiers within the list (e.g., Samantha Chabrinski). For example, the process 500 tracks movement of a mouse curser or arrow keys of the user are positioned over one of the identifiers within the list while listening for action from the mouse (e.g., left click) or keyboard (e.g., tab, enter, etc. activated). The mouse and keyboard listener can be performed using any combination of methods. If an identifier within the list is selected, then the process 400 will advance to block 420, otherwise the process will return to block 414.

At block 420, remaining text for the selected identifier is auto filled (or autocompleted, predictive text, etc.) to complete the reference identifier within the chat text entry area 338. The auto fill can execute in response to the user selecting (e.g., left clicking the mouse) the name from the list or hitting tab or enter if the first name on the list is correctly predicted. The name of the referenced person can be displayed as a reference with the special character (i.e., the question mark) followed by the full name of the referenced person. The text for the referenced person can also be distinguished from the text in the rest of the string. For example, as shown in FIG. 5E, the referenced person can include the special character and can be underlined.

The auto fill can be performed using any combination of methods that anticipate what the user typing within the text entry area 338 and suggest a word or phrase based on the activity of other users and your history. The reference identifier includes the triggering special character (i.e., “?”) and the string associated with the identifier (i.e., “first name and last name”). Continuing the above example, upon receiving a selection of the identifier Samantha Chabrinski from the list will cause the process 400 to auto fill the string “?S” or “?Sam” to “?Samantha Chabrinski”, as shown from FIG. 5D to FIG. 5F.

A reference can be made to any identifier without the identifier being linked to the chat session. For example, the reference can be created for any name within a user directory without the referenced name being the name of the one of the participants within the chat session. The person being referenced is not notified when the autofill is completed, regardless of if that person is participating in the chat session or not.

In addition to auto filling the reference identifier string with the text from the selected identifier, a link can be generated using the auto filled text. The link provides a lookup address to a profile associated with the identifier. The lookup address can include any combination of location information, such as a location within memory, a directory address, a web address, etc. The link, when selected by the user, can direct the user to the profile associated with the identifier. For example, the auto filled identifier can be changed into a hyperlink to a webpage for the full profile associated with the name for the identifier. The link generation can be performed by any combination of a client or server devices. For example, in response to receiving a selection of one of the identifiers (e.g., names) the server device can generate the link for the identifier and provide the link back to the client device for display. Alternatively, the link generation can be performed entirely by the client device.

FIG. 5F depicts the GUI 500 rendering the user entering the remaining text in the text string after the auto filled reference. The text following the reference is not distinguished in the same manner as the referenced person and should match the other text in the chat text entry area 338.

At block 422, the text entered within the chat text entry area 338, including the linked reference identifier are loaded into the chat window 336. For example, a sentence including the reference identifier is entered into the chat window 336 after detecting that the user has submitted (e.g., pressing submit button, hitting return, etc.) in the chat text entry area 338. FIG. 5G depicts the GUI 500 rendering the updated chat window 336 after the user entered the text from the chat text entry area 338. For example, a user can hit return or submit when they have typed all they wanted to type. The shared text message is then viewable by all other users within the chat session in their respective chat windows 336. Similar to the rendering of the reference in FIGS. 5F and 5G, the text for the referenced person can also be distinguished from the text in the rest of the string when provided within the chat window 336. For example, as shown in FIG. 5G, the referenced person can include the special character and be underlined as a hyperlink.

Once in the chat window 336, the sentence including the reference identifier is loaded and the reference identifier may be distinguished from the rest of the sentence. For example, if the reference identifier is a hyperlink, the text of the reference identifier can be underlined and/or colored blue to signify that it is a hyperlink. Similar, to block 414, the reference identifier within the chat window 336 can also include a preview when the process 400 detects that any user within the chat session hovers their cursor over the reference identifier. Additionally, the reference identifier can have additional functionality when selected. The additional functionality can include redirecting a user to a page including the profile associated with the reference identifier. The redirection can include any combination of methods, including opening a new window, opening another application (e.g., a web browser), updating a portion of the GUI 500 itself, or a combination thereof. For example, selecting the hyperlink of the reference identifier can cause a web browser to open the web page associated with the hyperlink. Continuing the above example, selecting the hyperlink can cause the web browser to load a web page having the profile associated with Samantha Chabrinski.

FIG. 5H depicts the GUI 500 rendering a quick view profile for the person named Samantha Chabrinski within the chat window 336. Similar to the quick view provided in FIG. 5D, the quick profile is rendered in response to the user hovering the mouse cursor over the name of Samantha Chabrinski (block 414). The quick view provided in FIG. 5H can be the same quick view profile provided in FIG. 5D or it can be a different profile view. By providing the quick profile views just by hovering the cursor over the reference name, a user can quickly preview each of the referenced name without having to click to select. If a user clicks on the reference identifier (with the hyperlink) a contact page will be loaded inside or outside of the chat window. The contact page can include a more comprehensive profile than what is provided in the quick view profile. This allows any users viewing the chat to quickly learn about any references people along with quick access to contact that person (e.g., view a chat button). As noted above, creating a reference link or selecting a reference link will not inform/notify the user being referenced. This process will continue as users activate the reference functionality during the chat session.

The entity being referenced is not notified when the reference to their identifier is entered into the chat window 336, regardless of if that entity is participating in the chat session or not. For example, a user associated with a referenced name is not notified that they have been referenced within a chat session and will have no knowledge that the conversation referred to them or their profile. Similarly, the user will not be referenced when their name is referenced in a chat window 336 or when a link is created or followed by one or more other users. There can be numerous reasons why it would be undesirable to notify other users any time that they are referenced in a chat. For example, if a user is frequently referenced within a company (e.g., Owner, president, etc.) they could become inundated with notifications, the users making reference to another user may not want that user to be aware that they are being discussed (e.g., being reviewed, discussing private information, etc.), it is unnecessary to disturb the referenced user (e.g., benign reference, casual conversation, etc.), it would require complicated programing and resources to track and notify users that are not included within a particular chat session, among others. Therefore, the Reference functionality provides the benefits of consistent and efficient autocompletion of identifiers (e.g., people's names), linking detailed information about an entity or user while not adding unnecessary notifications to those users.

Returning to block 418, the process 400 checks to determine whether a user has autocompleted the reference identifier. The autocompletion can be triggered using any combination of methods. For example, in response to suggesting a name, if the enter or tab key is depressed or the mouse is left clicked, the process 400 advances to block 420, which automatically completes the remainder of the string with the remainder of the suggested text. If the user does not auto-complete the text, then the process returns to block 404 where the text entry continues to be tracked.

The process 400 can continue to run and update while the user(s) is entering text within the text entry area 338. Once the user has completed their text entry and hits return, then the text entry area 338 is cleared and the text is moved to the chat window 336. In operation, the process 400 can be implemented to provide a mechanism in chat to automatically lookup and predict a reference to another user quickly to foster fluid introductions and connections.

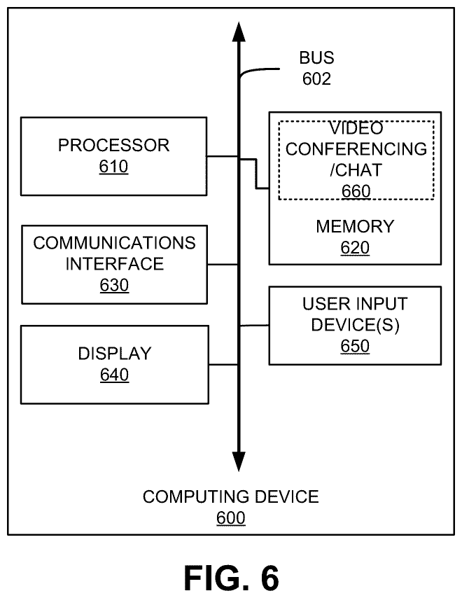

Referring now to FIG. 6, FIG. 6 shows an example computing device 600 suitable for use in example systems or methods for referencing an identifier for another user in chat. The example computing device 600 includes a processor 610 which is in communication with the memory 620 and other components of the computing device 600 using one or more communications buses 602. The processor 610 is configured to execute processor-executable instructions stored in the memory 620 to perform one or more methods for autocompleting references and creating reference links according to different examples, such as part or all of the example method 400 and GUI 500 described above with respect to FIG. 4 and FIGS. 5A-5H. The computing device 600, in this example, also includes one or more user input devices 450, such as a keyboard, mouse, touchscreen, microphone, etc., to accept user input. The computing device 600 also includes a display 640 to provide visual output to a user.

In addition, the computing device 600 includes a video conferencing application or chat application 660 to enable a user to join and participate in a video conference and/or chat session, such as a conventional meeting or webinar, by receiving multimedia streams from a video conference provider, sending multimedia streams to the video conference provider, joining and leaving breakout rooms, engaging in participant interactions over text messages. such as described throughout this disclosure, etc.

The computing device 600 also includes a communications interface 640. In some examples, the communications interface 430 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

1. A method for referencing a user in chat, the method comprising:
joining a chat session having a chat window for displaying text messages shared between at least a first user and a second user;
providing a text entry area to receive text messages from the first user;
receiving a reference special character and a character or character string corresponding to one or more names for a third user within the text entry area;
generating an interactive link to one of one or more names based on the reference special character and the character or character string associated with the reference special character; and
displaying the interactive link in the chat window without sending a notification referencing the third user in the chat session to the third user, the interactive link providing access to user information associated with the third user, the third user not participating in the chat session.

2. The method of claim 1, wherein the interactive link is to a profile for the user information associated the third user.

3. (canceled)

4. The method of claim 3, further comprising receiving a selection of the interactive link by the first user, and displaying at least a portion of the user information associated with the third user.

5. The method of claim 1, further comprising:
generating a list of the one or more names matching the character string, the one or more names each being associated with a different user profile card; and
displaying the list to one of the at least the first user and the second user.

6. The method of claim 5, wherein the list is ordered based on at least one prediction for who the one of the at least the first user and the second user intends to reference.

7. The method of claim 6, further comprising:
receiving a selection of a name from the list for the third user;
autocompleting the name of the third user in the text entry area; and
generating a hyperlink for the reference special character and the name.

8. The method of claim 5, further comprising:
tracking characters entered into the text entry area;
identifying a space adjacent to and prior to the reference special character adjacent to an alphanumeric character; and
triggering the list of the one or more names in response to the identifying.

9. A system comprising:
one or more processors; and
a memory coupled to the one or more processors, the memory storing a plurality of instructions executable by the one or more processors, the plurality of instructions comprising instructions that when executed by the one or more processors cause the one or more processors to:
join a chat session having a chat window for displaying text messages shared between at least a first user and a second user;
provide a text entry area to receive text messages from the first user;
receive a reference special character and a character or character string corresponding to one or more names for a third user within the text entry area;
generate an interactive link to one of one or more names based on the reference special character and the character or character string associated with the reference special character; and
cause the interactive link to be displayed in the chat window without sending a notification referencing the third user in the chat session to the third user, the interactive link providing access to user information associated with the third user, the third user not participating in the chat session.

10. The system of claim 9, wherein the interactive link is to a profile for the user information associated the third user.

11. (canceled)

12. The system of claim 11, wherein the plurality of instructions further comprises instructions that when executed by the one or more processors cause the one or more processors to receive a selection of the interactive link by the first user, and displaying at least a portion of the user information associated with the third user.

13. The system of claim 9, wherein the plurality of instructions further comprises instructions that when executed by the one or more processors cause the one or more processors to:
generate a list of the one or more names matching the character string, the one or more names each being associated with a different user profile card, wherein the list is ordered based on at least one prediction for who the one of the at least the first user and the second user intends to reference;
display the list to one of the at least the first user and the second user;
receive a selection of a name from the list for the third user;
autocomplete the name of the third user in the text entry area; and
generate a hyperlink for the reference special character and the name.

14. The system of claim 13, wherein the plurality of instructions further comprises instructions that when executed by the one or more processors cause the one or more processors to:
track characters entered into the text entry area;
identify a space adjacent to and prior to the reference special character adjacent to an alphanumeric character; and
trigger the list of the one or more names in response to the identifying.

15. A non-transitory computer-readable memory storing a plurality of instructions executable by one or more processors, the plurality of instructions comprising instructions that when executed by the one or more processors cause the one or more processors to:
join a chat session having a chat window for displaying text messages shared between at least a first user and a second user;
provide a text entry area to receive text messages from the first user;
receive a reference special character and a character or character string corresponding to one or more names for a third user within the text entry area;
generate an interactive link to one of one or more names based on the reference special character and the character or character string associated with the reference special character; and
cause the interactive link to be displayed in the chat window without sending a notification referencing the third user in the chat session to the third user, the interactive link providing access to user information associated with the third user, the third user not participating in the chat session.

16. The non-transitory computer-readable memory of claim 15,
wherein the interactive link is to a profile for the user information associated the third user.

17. (canceled)

18. The non-transitory computer-readable memory of claim 17, wherein the plurality of instructions further comprises instructions that when executed by the one or more processors cause the one or more processors to receive a selection of the interactive link by the first user, and displaying at least a portion of the user information associated with the third user.

19. The non-transitory computer-readable memory of claim 15, wherein the plurality of instructions further comprises instructions that when executed by the one or more processors cause the one or more processors to:
generate a list of the one or more names matching the character string, the one or more names each being associated with a different user profile card, wherein the list is ordered based on at least one prediction for who the one of the at least the first user and the second user intends to reference;
display the list to one of the at least the first user and the second user;
receive a selection of a name from the list for the third user;
autocomplete the name of the third user in the text entry area; and
generate a hyperlink for the reference special character and the name.

20. The non-transitory computer-readable memory of claim 19, wherein the plurality of instructions further comprises instructions that when executed by the one or more processors cause the one or more processors to:
track characters entered into the text entry area;
identify a space adjacent to and prior to the reference special character adjacent to an alphanumeric character; and
trigger the list of the one or more names in response to the identifying.
